(19) United States
(12) Patent Application Publication
(10) Pub. No.: US 2026/0092784 A1
(43) Pub. Date: Apr. 2, 2026

(54) CASINO PATHFINDING

(71) Applicant: Aristocrat Technologies, Inc., Las Vegas, NV (US)

(72) Inventors: Robert Butler, Austin, TX (US); Eric Santana, Austin, TX (US)

(21) Appl. No.: 18/902,614

(22) Filed: Sep. 30, 2024

(51) Int. Cl. G01C 21/20; G01C 21/00

(52) U.S. Cl. CPC G01C 21/206; G01C 21/3889; G01C 21/3896

(57) ABSTRACT

A navigation technique is performed using live data from a casino management system. The technique includes obtaining a digital map of an integrated physical environment, and obtaining location information for an electronic gaming machine in the integrated physical environment. In addition, one or more live characteristics of the electronic gaming machine is obtained from the casino management system. A mapping interface is generated based on the digital map and the location information for the electronic gaming machine, and the electronic gaming machine is presented in accordance with the one or more live characteristics.

### RELATED APPLICATIONS

The current patent application is related to U.S. patent application Ser. No. 18/897,821, which was filed on Sep. 26, 2024, and which is incorporated by reference herein.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a flowchart of a technique for generating mapping interface, in accordance with one or more embodiments.

FIG. 5 depicts a flowchart of a technique for generating navigation information in a mapping interface, in accordance with one or more embodiments.

FIG. 6 depicts a flowchart of a technique for selecting a navigable path, in accordance with one or more embodiments.

FIG. 7A-7D illustrates example graphical user interfaces, in accordance with one or more embodiments.

FIG. 8 depicts a system diagram for a client device configurable to navigate and interact with the game path and many games, in accordance with a more embodiments.

### DETAILED DESCRIPTION

Embodiments described herein are directed to a digital mapping interface for an integrated physical environment such as a casino, hotel, convention hall, shopping mall, entertainment complexes, and connected navigable locations. The digital mapping interface enhances user navigation and experience by providing real-time navigation information, along with live information for target locations within the integrated physical environment.

According to one or more embodiments, a digital map of the integrated physical environment can be obtained. The digital map may include a floorplan, layout, or other information for the integrated physical environment. The digital map may indicate the location of tagged or mapped components within the environment. In some embodiments, the tagged components may be registered with a server which maintains live data about the object. For example, the object may be a slot machine or other gaming device which is registered with a casino management system (CMS) which is configured to manage real time status information for gaming machines and other gaming components. This includes information such as availability, operational status, and maintenance needs, ensuring that users always have the most current information. Additionally, or alternatively, the object may be associated with a property or third party service which is represented on the digital map. For example, a restaurant within the integrated environment may host information such as menus, offers, hours, and the like on a third party device which can additionally feed into the digital map.

According to one or more embodiments, a user may select a target location on the digital map, and in turn the system may determine a recommended navigable path. In some embodiments, the navigable path may be determined based on a cost based algorithm. The algorithm may consider various factors, such as time, distance, promotional offers, traffic patterns, and accessibility to identify the optimal path. The system also supports multi-level navigation by considering elevators, escalators, staircases, and the like as navigable components of the integrated physical environment.

Additionally, the system can incorporate live characteristics of nearby services and amenities, even those outside the immediate integrated environment. For example, a user can search the integrated environment for a particular service or object. If the service or object is available off-map, the system may access live information for the service or object, and present a dynamic digital interface generated from real-time data. This may include, for example, providing directional indicators and estimated travel times to these external locations.

The embodiments described herein are associated with various technical innovations. For example, the system utilizes a combination of sensors, including RFID, BLE, and Ultra-Wideband technology, to accurately track the location of EGMs and other objects within the integrated physical environment. Further, by using terrain penalties and box blur technique to refine the navigation process, the techniques described herein provide an improved technique for determining a navigable path is provided. The embodiments described herein solve technical problems in navigation by generating an enhanced map based on live location data and other characteristics in an integrated physical environment to generate a more efficient navigational path and mapping interface based on live conditions of the integrated physical environment.

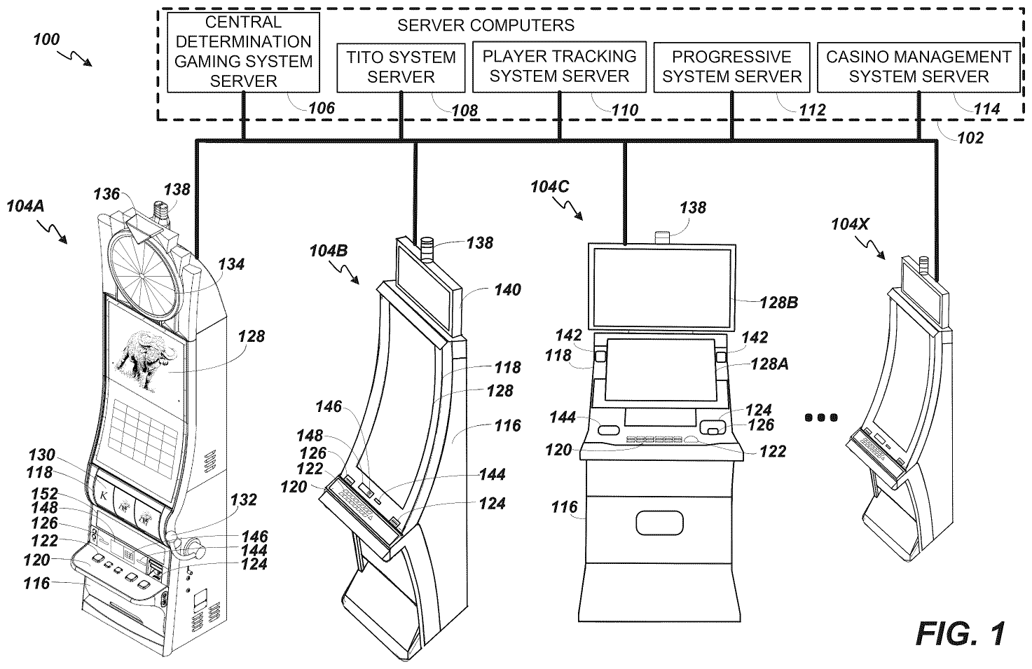

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system (CMS) 114, which may include one or more servers. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat^{®}Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

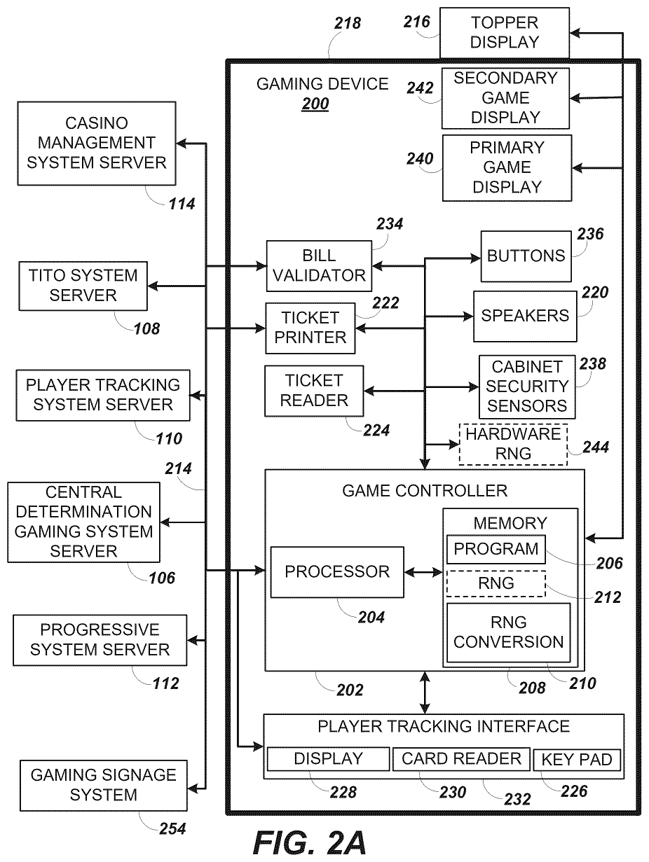

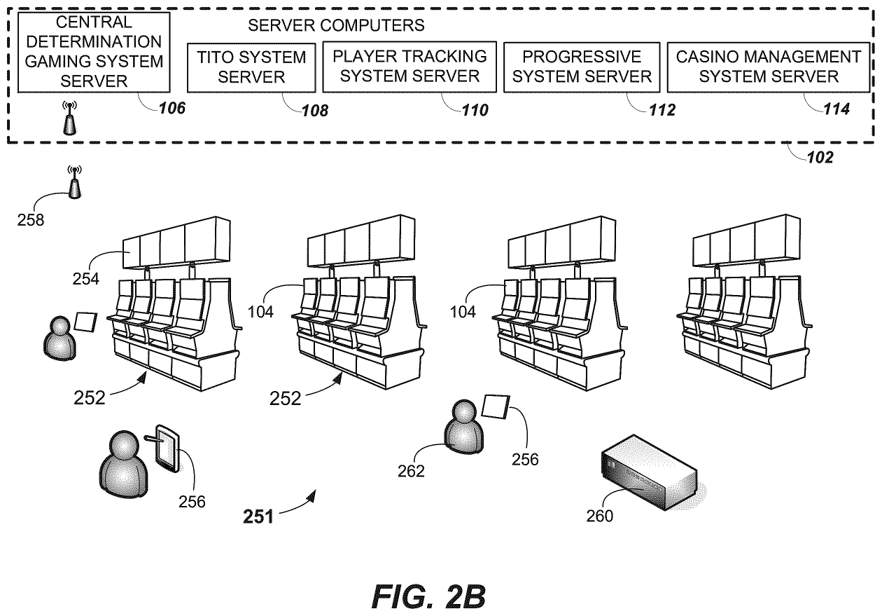

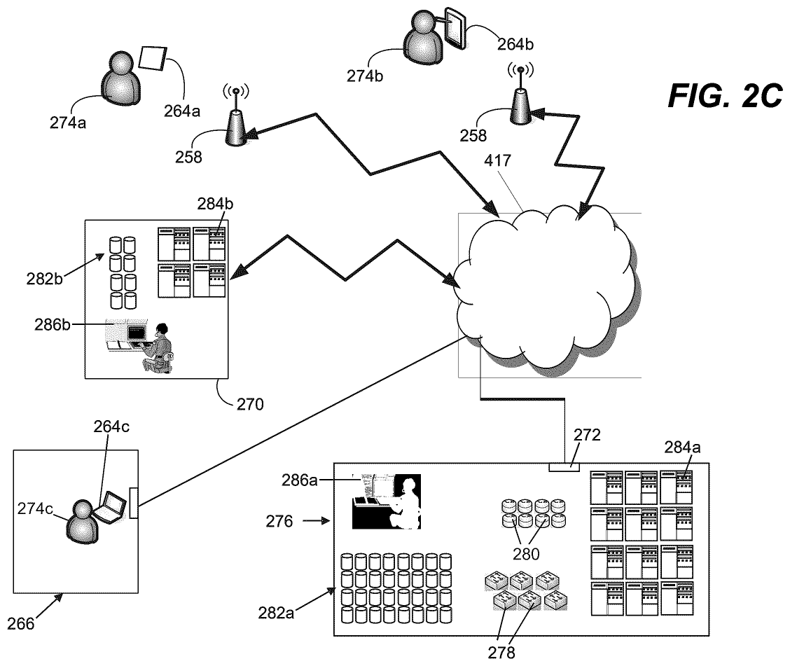

Many or all of the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system (CMS).

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during the course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

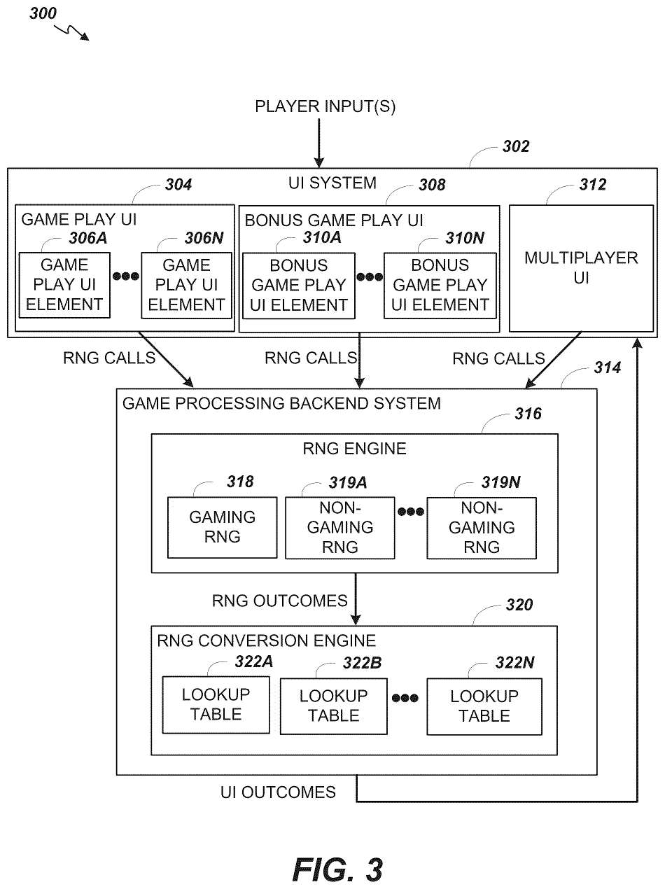

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

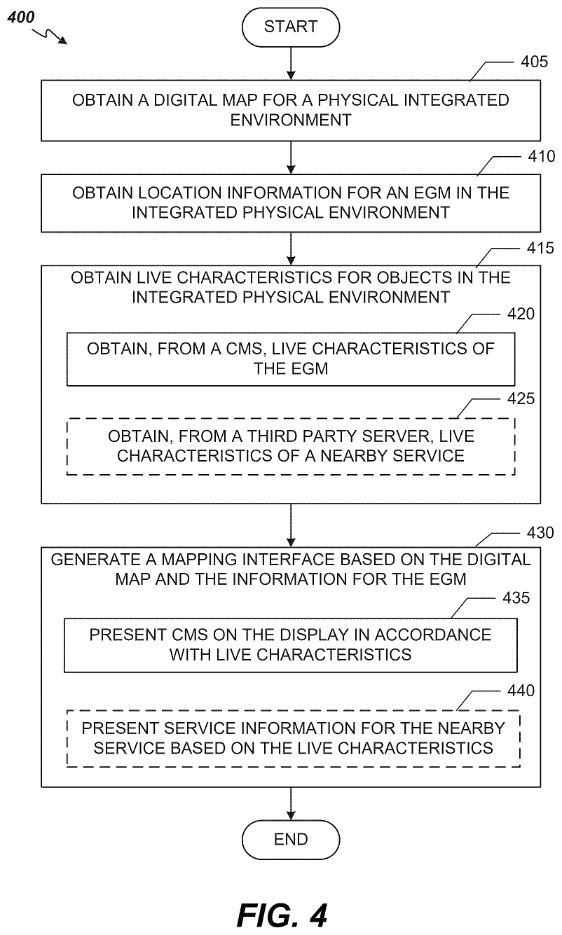

FIG. 4 depicts a flowchart 400 illustrating an example technique for generating a mapping interface for an integrated physical environment, according to some embodiments of the invention. For purposes of clarity, the various processes are described as being performed by particular components. However, in some embodiments, the various processes may be performed by additional or alternative components. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

FIG. 4 illustrates a flow diagram of a technique for generating a set of paths, in accordance with one or more embodiments. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

At block 405, the flowchart 400 includes obtaining a digital map for a physical integrated environment. The physical integrated environment may comprise one or more connected navigable environments, such as hotels, parking garages, casinos, shopping centers, conference centers, entertainment centers, or any other locations or sets of locations that are integrated together in a navigable environment, for example by a pedestrian, guest, or the like. The digital map may be predefined for the integrated physical environment and may indicate static boundaries and obstacles. In some embodiments, the digital map may include, or may be associated with, tagged objects for which location information can be obtained or updated.

The flowchart 400 proceeds to block 410, where location information is obtained for one or more EGMs in the physical integrated environment. The EGM may be any device that allows a user to play a game of chance for a monetary outcome, such as a slot machine, or any other gaming device. The location information may comprise coordinates, identifiers, or other data that indicate the position or placement of the EGM on the digital map. The location information may be obtained from a casino management system (CMS) that tracks and manages the EGMs in the physical integrated environment. In some embodiments, the location of the EGM may be determined from sensor data or that detects the location of the EGMs, such as radio frequency identification (RFID), Bluetooth low energy (BLE), ultra-wide band (UWB), and/or other wireless technologies. Additionally, or alternatively, computer vision techniques may be used to detect the location of the EGMs. In some embodiments, the location may be embedded in the digital map in the form of metadata, or may be referenced by the digital map, such that the location of the EGM can be incorporated into the digital map.

At block 415, the method 400 obtains live characteristics for objects in the integrated physical environment. For example, as shown at block 420, live characteristics may be obtained for the EMG from the CMS. The live characteristics may comprise any data or information that reflects the current state or condition of the EGM, such as availability, occupancy, functionality, maintenance, performance, popularity, promotions, offers, jackpots, game types, or any other relevant characteristics.

Optionally, as shown at block 425, the flowchart 400 includes obtaining, from a third-party server, live characteristics for a nearby service. The nearby service may comprise any service or facility that is located within the integrated physical environment and represented on the digital map. In some embodiments, the nearby service may be near or adjacent to the physical integrated environment, such as a restaurant, a bar, a theater, a store, a spa, a gym, a park, a museum, or any other service or facility that may be of interest or convenience to a user. The live characteristics for the nearby service may comprise any data or information that reflects the current or dynamic state or condition of the nearby service, such as availability, occupancy, functionality, performance, popularity, promotions, offers, schedules, reservations, menus, prices, ratings, reviews, or any other relevant characteristics. The third-party server may comprise one or more systems or network devices that provides or hosts information or functionality for the nearby service, such as a website, an app, a database, a cloud service, or any other server or system.

The flowchart 400 proceeds to block 430, where the system generates a mapping interface based on the digital map and the information for the EGM. The mapping interface may then couple the static navigation information from the digital map with the live information to generate an enhanced digital map. The mapping interface may comprise a graphical user interface (GUI) that displays the enhanced digital map and the location information for the EGM on a display of a user's mobile device. For example, as shown at block 435, the mapping interface may display the live characteristics for the EGM. For example, the mapping interface may display an icon, a symbol, a UI panel, or any other component that represents the live characteristics for the EGM. Similarly, as shown at optional block 440, the nearby service may also be presented with live service information on the map.

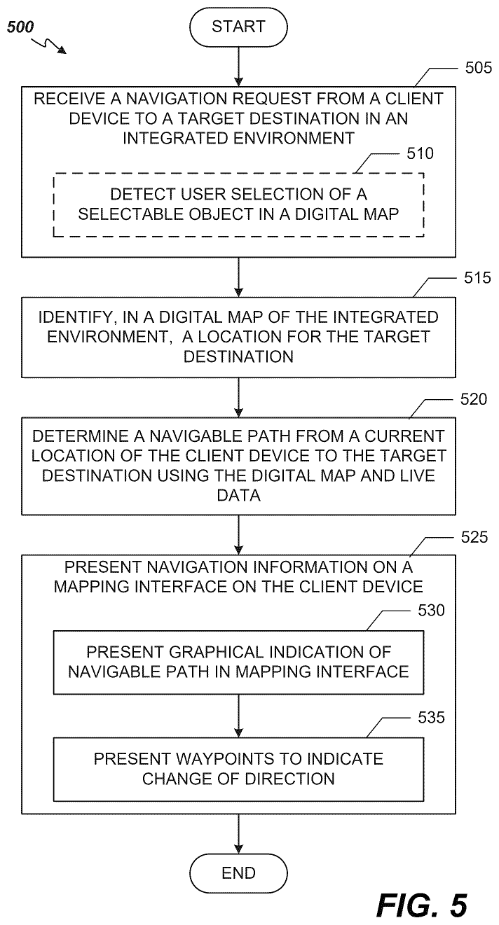

Turning to FIG. 5, a flowchart of a technique for providing a navigable path to a user is presented. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

The flowchart 500 begins at block 505, where a navigation request is received from a user client device. The navigation request may include a request to navigate to a target destination in an integrated physical environment. According to some embodiments, the target destination may comprise a tagged object in the integrated physical environment. Examples of target destinations include information desks, EGMs, restaurants, bars, bathrooms, retail stores, pools, theaters, and the like. In some embodiments, the target destination may be any location in the integrated physical environment.

The navigation request can be received in a number of ways. For example, as shown at optional block 510, the navigation request may comprise a user selection that indicates a target destination that the user wants to reach in the integrated physical environment. The user selection may be received in the form of user input, such as a touch, a tap, a swipe, a click, a hover, or any other gesture or action that indicates the user's interest or preference for the selectable object. In some embodiments, the user may use voice commands or other techniques for providing the selection. In some embodiments, the user selection may be a selection of a selectable object in a digital map or an enhanced digital map. The selectable object may comprise any object that can be selected by the user via the mapping interface. The enhanced digital map presented to the user may be augmented with live characteristics for one or more objects in the integrated physical environment.

The flowchart 500 proceeds to block 515, where a location for the target destination is identified in the enhanced digital map presented to the user. The location for the target destination may comprise coordinates, identifiers, or other data that indicate the position or placement of the target destination on the enhanced digital map.

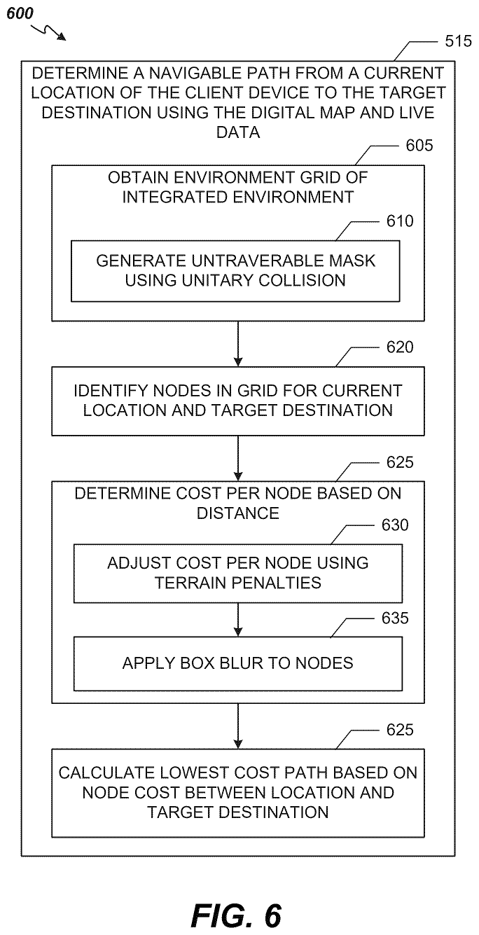

At block 520, the flowchart 500 includes determining a navigable path from a current location of the user mobile device to the target destination using the enhanced digital map, for example based on the live data. The navigable path may comprise a sequence of nodes, steps, directions, or instructions that guide the user from the current location of the user device to the target destination in the integrated physical environment. As will be described in greater detail below with respect to FIG. 6, a pathfinding algorithm can be applied to determine the recommended path.

At block 525, the flowchart 500 includes presenting navigation information on a mapping interface on the user device. The navigation information may comprise any data or information that assists or facilitates the user's navigation from the current location of the user device to the target destination in the integrated physical environment. The navigation information may comprise a graphical indication, a symbol, a color, a text, or any other indicator that represents the navigable path from the current location of the user device to the target destination the distance, the time, the direction, the steps, the instructions, or any other relevant information.

As shown at block 530, the navigable path may be presented on the mapping interface in the form of a graphical indication. The graphical indication may comprise a line, a curve, a shape, a highlight, a shadow, or any other graphical element that visually depicts. Further, as shown at block 535, the mapping interface may also show waypoints that indicate changes of direction or elevation along the navigable path. The waypoints may comprise any points or locations that mark a transition or a variation in the navigable path from the current location of the user device to the target destination in the integrated physical environment. The waypoints may indicate changes of direction, such as turns, curves, bends, or angles, or changes of elevation, such as stairs, elevators, escalators, ramps, or bridges. The waypoints may be presented as icons, symbols, or any other indicators that alert or inform the user of the changes of direction along the navigable path. The user can then use the navigable path and waypoints to navigate to the target destination.

FIG. 6 is a flow diagram illustrating an example method 600 for determining a navigable path from a current location of the user device to the target destination, as shown at block 515 of FIG. 5. Although the flow diagram depicts various actions and processes performed in a particular order, it should be understood that in some embodiments, the actions and processes may be performed in a different order. Further, in some embodiments, some or all of the actions may be performed concurrently. In addition, in some embodiments not all processes or actions may be necessary to complete the tasks described, or additional processes or actions may be needed.

The flowchart 500 begins at block 605, where an environment grid of the integrated physical environment is obtained. The environment grid may comprise a two-dimensional or three-dimensional representation of the integrated physical environment in a grid format indicating whether the individual cells or tiles are traversable. The environment grid may be obtained from the digital map that has been enhanced with live data indicating characteristics of the environment, such as locations of objects, traffic patterns, available paths or devices such as elevators or escalators, and the like. In some embodiments, the environment grid may be an occupancy grid representing the integrated physical environment in a grid pattern, where each cell or tile in the grid indicates whether the cell or tile in the grid is occupied by a known object or obstacle such as walls, doors, fixtures, or the like.

According to some embodiments, as shown at block 610, the system generates an untraversable mask using unitary collision. Unitary collision may be used to consider obstructions identified from the digital map and obstructions determined from live data to determine whether each based on the digital map and location information of tagged objects from live data. In some embodiments, the live data may include sensor data from sensors around the integrated physical environment, such as Lidar, depth sensing, sonar, near infrared edge detectors, and bumpers, which may provide sensor data from which occupancy data and other navigable data such as traffic patterns and the like can be determined. The information from the various sources may be considered in combination to detect collisions or overlaps between objects or elements in the environment grid. The unwalkable mask may comprise a mask or a layer that identifies the cells, tiles, or units in the environment grid that are not navigable or accessible by the user based on the digital map and/or unity collision.

At block 615, the method 600 identifies nodes in the grid for the current location and the target destination. For example, a user's current location may be mapped to a first node in the environment grid, and the selected target destination may be mapped to a second node in the environment grid. The user's current location may be determined based on sensor data on the user's device, sensor data from environment sensors within the integrated physical environment, or some combination thereof. In some embodiments, the user's current location may be self-selected on the enhanced digital map. The target location may be the location selected by the user on the enhanced digital map, or may be determined from a user selection, and can then be mapped to the environment grid to determine a destination node.

The flowchart 600 proceeds to block 620, where a cost per node is determined for at least some of the nodes. The cost per node may comprise a value or a measure that indicates the difficulty or the expense of reaching or traversing a node in the environment grid. In some embodiments, the cost per node may be based on distance. For example, nodes closer to the destination have a lower cost than nodes further away from the destination. According to one or more embodiments, the cost per node may be predefined, or may be determined dynamically based on live data, or some combination thereof. For example, a global cost map may be predefined based on the occupancy grid that has previously been stored, and may indicate a predefined cost for nodes corresponding to static objects in the environment such as walls, fixtures, barriers, or the like. A local costmap can then be determined to handle dynamic obstacles, such as tagged objects within the physical integrated environment, operational status of elevators, escalators and the like, traffic patterns, and other characteristics in the integrated physical environment that affect traversability.

The cost per node may be determined based on one or more factors, such as distance, promotional offers, traffic patterns, accessibility, availability, occupancy, functionality, performance, popularity, or any other factors that affect the user's preference or convenience. There are various cost-based algorithms that can be used to determine path. An example is Dijkstra's algorithm, which finds the shortest path from the start node to all other nodes in the graph. Another example is the A* (A-star) algorithm, which is a modified version of Dijkstra's algorithm, and finds the shortest path from the start node to the target node in the graph, and considers information about the target node. The heuristic is a function that estimates the minimum cost between a given node and a target node to prioritize nodes that are closer to the destination. For example, a node with the lowest cost considering the distance from the start and distance to the end is found. If two nodes have the same lowest cost, the node closer to the destination is prioritized. Neighboring nodes are looped through to determine walkability and whether a new path to a neighbor is shorter.

To that end, the technique may include, as shown at block 630, adjusting the cost per node using terrain penalties. The terrain penalties may comprise additional values or measures that increase or decrease the cost per node based on the characteristics or features of the nodes or the environment grid. For example, terrain penalties may be applied based on high traffic areas, restricted zones, difficulty of access such as stairs or other accessibility features, and the like. In some embodiments, terrain penalties may also be adjusted to influence navigation that includes areas of interest. In one example, game machine locations may cause an increase or decrease in terrain penalties. For example, game machines having new games may be incentivized, whereas older games may be associated with a greater terrain penalty. As another example, terrain penalties may be based on operability, such that EGMs under maintenance are penalized greater than working machines. As another example, promotional zones, new amenities, or areas hosting special events may have a reduced cost to drive foot traffic toward the area. The terrain penalties can be dynamically updated based on real-time data, such as changes in traffic patterns, the introduction of new obstacles, or the start of promotional events. Further, the terrain penalties may be automatically determined based on predefined values, and/or may be determined based on user preference. For example, a user may wish to avoid certain areas such as staircases, narrow hallways, or other areas which may have accessibility issues. As another example, a user may wish to avoid loud areas or crowded areas, regions which may allow smoking, strobing lights, or the like. To that end, the terrain penalties may be based, at least in part, on user input or user profile information. In some embodiments, raycasting may be used to find EGMs or other gaming objects in a given layer of the enhanced digital map. Each layer of the enhanced digital map may define the terrain penalty as an addition to the combination of the distance determination.

At block 635, a box blur is applied to the nodes. The box blur may comprise a filter or a function that smooths or averages the values or measures of the nodes in the environment grid, taking into consideration the node values, such as the occupied nodes from the untraversable mask and the terrain penalties. For example, the untraversable mask may indicate nodes which are not at all traversable, whereas the terrain penalties may provide some value to the remaining nodes based on various factors. The box blur may therefore produce a more natural navigational path by assigning values to nodes near obstructions or having terrain penalties in order to avoid sharp corners or edges. The box blur may use a kernel or a matrix that specifies the weights or coefficients for each node and its neighboring nodes in the environment grid. The box blur may multiply each node by its corresponding weight or coefficient in the kernel or matrix, and then sum up the results to obtain a new value or measure for each node in the environment grid.

The flowchart 600 concludes at block 625, where the lowest cost path b is calculated based on the node cost between the current location and the target destination. The lowest cost path may comprise a path that has the minimum total cost among all possible paths between the current location and the target destination in the environment grid. The lowest cost path may be calculated by applying a pathfinding algorithm that can identify a candidate path that minimizes cost based on values assigned to the nodes along the path.

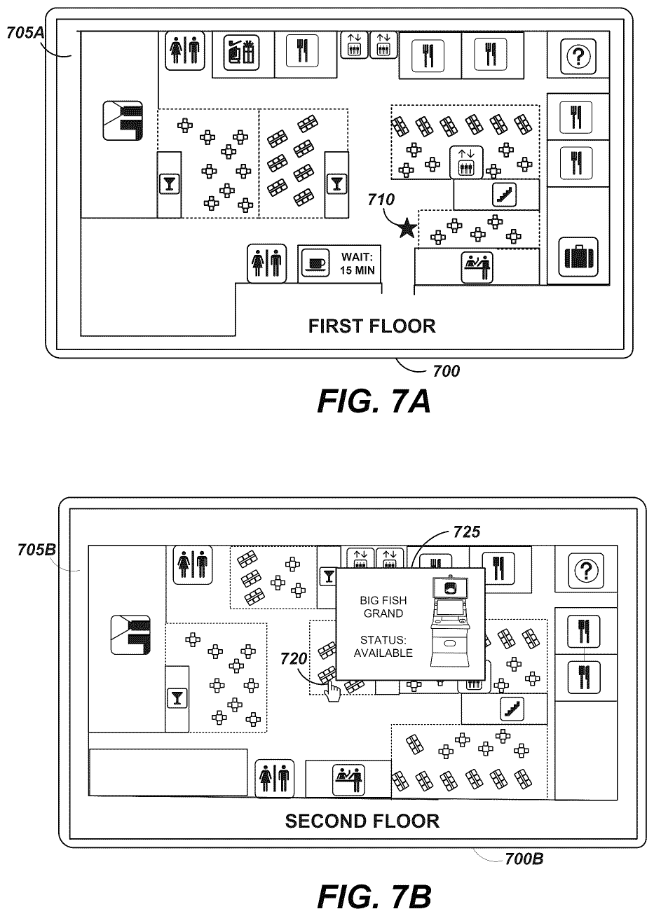

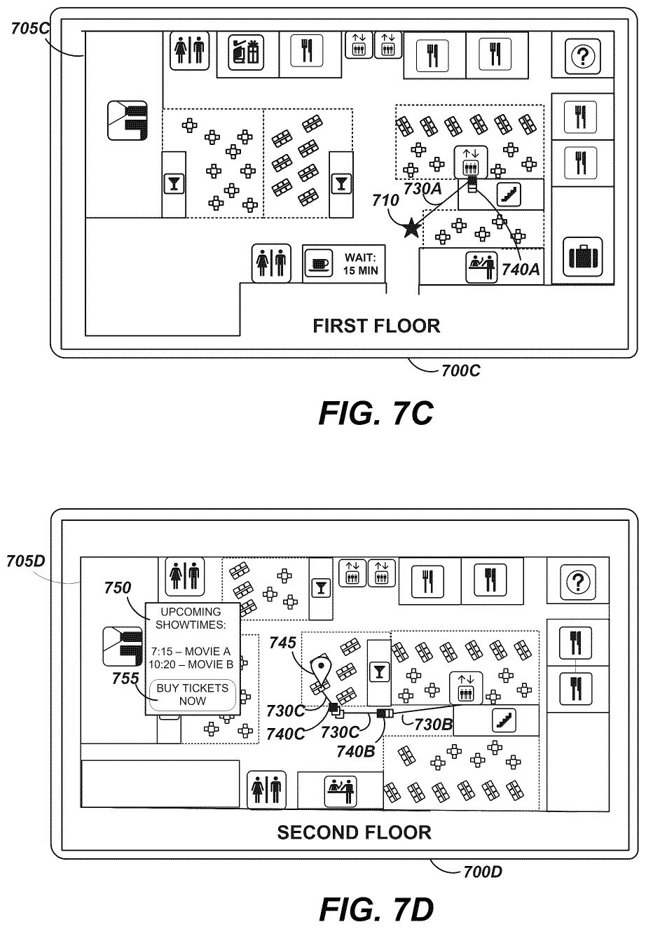

FIG. 7A to FIG. 7D are diagrams illustrating example mapping interfaces for an EGM in an integrated physical environment, according to some embodiments of the invention. The mapping interfaces may be generated and presented by the method 400 shown in FIG. 4.

FIG. 7A shows an example mapping interface 705A for a first floor of an integrated physical environment on a mobile device 700. The mapping interface 705A displays a digital map of the first floor of a physical environment and the current location of a user 710 on the first floor. The mapping interface 705A also displays live characteristics for the physical integrated environment, current location of the user 710, and nearby services on the first floor. The live characteristics may comprise icons, symbols, colors, texts, sounds, vibrations, or any other indicators that represent the current or dynamic state or condition of the physical integrated environment, the current location of the user 710, and the nearby service. For example, the live characteristics may indicate that the current location of the user 710 is near a coffee shop that has a wait time of 15 minutes.

FIG. 7B shows an example mapping interface 705B for a second floor of the integrated physical environment on a mobile device 700B. The mapping interface 705B displays a digital map of the second floor and, as an example, a location of an EGM 720. The mapping interface 705B also displays live characteristics for the EGM 720. The live characteristics may comprise icons, symbols, colors, texts, or any other indicators that represent the current or dynamic state or condition of the EGM 720. In the example of FIG. 7B, the live characteristics indicate that the EGM 720 is associated with the Big Fish Grand game, and that the machine is available for play. In some embodiments, the live characteristics may be presented in a separate user interface panel, as shown at panel 725, when the corresponding object is selected, such as EGM 720. According to some embodiments, the information for panel 725 may be obtained from a CMS communicably connected to the EGM 720 and the mobile device 700B, thereby allowing for the live data to be current.

FIG. 7C shows an example mobile device 700C for the first floor of the integrated physical environment after a path has been determined between the current location 710 and the EGM 720. The mobile device 700C displays a digital map of the first floor and a current location of a user on a mapping interface 705C of the first floor. The mapping interface 705C now shows a path segment 730A toward the EGM 720. In this example, the EGM is on a second floor. The system may determine that the path with the lowest cost is via the elevator. Thus, path segment 730A leads a user from the current location 710 to the elevator. The mapping interface 705C also shows a waypoint 740A, indicating to the user a change of direction. In this example, waypoint 740 is at the elevator, which needs to be taken to reach the second floor.

FIG. 7D shows an example mobile device 700D displaying a mapping interface 705D of the second floor of the integrated physical environment, and the target destination 745 along with a remainder of the path to the target destination 745D. The navigation information includes path segments 730B, 730C, and 730D, which lead a user from the elevator (taken up from the first floor, as indicated above with respect to FIG. 7C. In addition, waypoints 740B and 740C show changes in direction along the path segments. The target destination 745 is also identified on the mapping interface as selected by the user.

According to some embodiments, as a user traverses the integrated physical environment, live data may dynamically be presented which may be of interest to the user. For example, mapping interface 705D shows a theater on the left side of the display. A determination may be made that upcoming showtimes are available at the theater. Thus, panel 750 may present live information for the theater. According to some embodiments, the mapping interface 705D may interface with other services, such as a ticket purchasing service, such that the mapping interface 705D provides functionality to utilize those services from the mapping interface. Thus, panel 750 additionally includes a user input component that allows a user to purchase tickets for the theater. The ticket purchase may be made within the mapping interface, such as with an API which ties functionality to the ticket purchasing service. Alternatively, the selectable component 755 may navigate the mobile device 700D to a website or application from which the ticket purchase may be made.

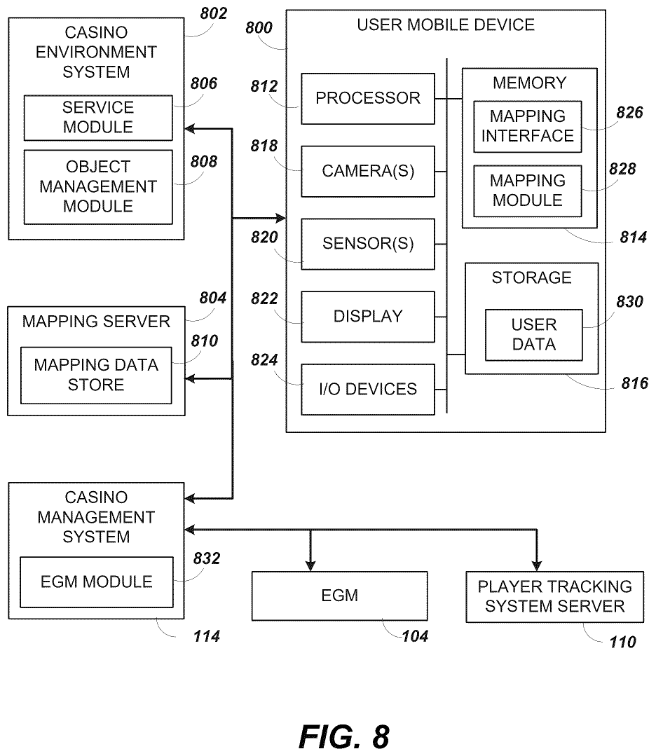

FIG. 8 depicts a system diagram for generating and presenting navigable paths in an integrated physical environment, in accordance with one or more embodiments. The system may comprise a user mobile device 800 that communicates with a casino environment system 802, mapping server 804 and a CMS 114 via a network. The user mobile device 800 may comprise any device that can communicate with other network components, such as a cellular network, a Wi-Fi network, a Bluetooth network, or any other wireless network. The user mobile device 800 may comprise a smartphone, a tablet, a laptop, a wearable device, or any other device that has a display 822, a processor 812, a memory 814, a storage 816, input/output (I/O) devices 824, and a camera 818 and/or other sensor module 820.

User mobile device 800 includes one or more processors 812. Processor 812 represents a general-purpose processor, a specialized processor intended to perform certain functional tasks, or a combination thereof. As an example, processor 812 can be a central processing unit (CPU) that has one or more multi-core processing units and memory mediums (e.g., cache memory) that function as buffers and/or temporary storage for data. Alternatively, processor 812 can be a specialized processor, such as an application specific integrated circuit (ASIC), graphics processing unit (GPU), field-programmable gate array (FPGA), digital signal processor (DSP), or another type of hardware accelerator. In another example, processor 812 is a system on chip (SoC) that combines and integrates one or more general-purpose processors and/or one or more specialized processors. Although FIG. 8 illustrates that user mobile device 800 includes a single processor 812, user mobile device 800 is not limited to this representation and instead can include multiple processors 812 (e.g., two or more processors), and may be of a same or different type.

FIG. 9 illustrates that processor 812 is operatively coupled to memory 814. Memory 814 is defined herein as including volatile and nonvolatile memory and other types of non-transitory data storage components. Volatile memory is memory that do not retain data values upon loss of power. Nonvolatile memory is memory that do retain data upon a loss of power. Examples of memory 814 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 8 illustrates that user mobile device 800 includes a single memory 814, user mobile device 800 could include multiple memories 814 for storing program instructions and/or data.

An example of computer executable modules in memory 814 include mapping interface 826 and mapping module 828. Mapping module 828 may be configured to generate navigational information for the user mobile device, and may be used to generate the enhanced digital map from predefined and live data. For example, the mapping module 828 may obtain a digital map for the integrated physical environment from a mapping data store 810 of a mapping server 804. The mapping module 828 may also obtain live data. For example, live data related to gaming machines may be obtained from EGM module 832 of the CMS 114. Additionally, or alternatively, live data related to traffic, services, or the like may be obtained from casino environment system 802, which may be configured to manage tagged objects and other sensors in the physical integrated environment which provide live information regarding the environment. For example, object management module 808 may be configured to manage tagged objects or regions, such as promotional areas, retail centers, restaurants, table games, or other objects for which live data may be provided. In addition, casino environment system 802 may include a service module 806 which may provide live information or services for components of the physical integrated environment. For example, the service module 806 may provide an interface to additional information or services for restaurants, venues, and the like within the physical integrated environment. The mapping module 828 may thereby be configured to generate an enhanced digital map using the retrieved map and the live data.

The mapping interface 826 may be configured provide the enhanced digital map to the user, for example on display 822. The mapping interface may also be configured to receive target destinations and determine navigational paths to target destinations as described above. In some embodiments, the mapping interface may rely on user-specific data, for example from user data 830 in storage 816 to determine a navigational path. A location of the user mobile device 800 may serve as a starting point, and may be determined from location data collected by sensor(s) 820.

CMS 114 may be configured to manage live data for EGMs within the integrated physical environment, such as EGM 104. Live data may include, for example, game information, graphics, jackpot information, maintenance status, occupancy, and the like. FIG. 8 also depicts that the CMS 114 is connected over a network to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. Information from the player tracking system 110 may also be used to determine terrain penalties for the nodes in the map.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A non-transitory computer readable medium comprising computer readable code executable by one or more processors to:
obtain a digital map of an integrated physical environment;
obtain location information for an electronic gaming machine (EGM) in the integrated physical environment;
obtain, from a casino management system, one or more live characteristics of the EGM; and
generate a mapping interface with an enhanced digital map based on the digital map and the one or more live characteristics of the EGM.

2. The non-transitory computer readable medium of claim 1, further comprising computer readable code to:
receive, from the mapping interface at a mobile device, a navigation request to the EGM; and
determine a navigable path from a current device location to a location of the EGM based on the location information for the EGM.

3. The non-transitory computer readable medium of claim 2, wherein the computer readable code to determine the navigable path comprises computer readable code to:
apply a cost-based algorithm within the digital map to identify a candidate path to minimize cost, wherein cost is determined based on at least one of a group consisting of: time to the EGM, distance to the EGM, promotional offers, traffic patterns, and accessibility.

4. The non-transitory computer readable medium of claim 2, further comprising computer readable code to:
present a graphical indication on the mapping interface of a local device; and
present a graphical indication of the navigable path.

5. The non-transitory computer readable medium of claim 1, wherein the one or more live characteristics are associated with an availability of the EGM.

6. The non-transitory computer readable medium of claim 1, further comprising computer readable code to:
obtain, from a third-party system associated with a location on the digital map, one or more live characteristics for the location, wherein the location is presented in the enhanced digital map in accordance with the one or more live characteristics for the location.

7. The non-transitory computer readable medium of claim 1, further comprising computer readable code to:
determine an additional target destination associated with the location on the digital map; and
in accordance with a determination that the additional target destination is outside the integrated physical environment:
present live characteristics for the additional target destination, and
present a directional indicator on the digital map toward the additional target destination.

8. A method, comprising:
obtaining a digital map of an integrated physical environment;
obtaining location information for an electronic gaming machine (EGM) in the integrated physical environment;
obtaining, from a casino management system, one or more live characteristics of the EGM; and
generating a mapping interface with an enhanced digital map based on the digital map and the one or more live characteristics of the EGM.

9. The method of claim 8, further comprising:
receiving, from the mapping interface at a mobile device, a navigation request to the EGM; and
determining a navigable path from a current device location to a location of the EGM based on the location information for the EGM.

10. The method of claim 9, determining the navigable path comprises:
applying a cost-based algorithm within the digital map to identify a candidate path to minimize cost, wherein cost is determined based on at least one of a group consisting of: time to the EGM, distance to the EGM, promotional offers, traffic patterns, and accessibility.

11. The method of claim 9, further comprising:
presenting a graphical indication on the mapping interface of a local device; and
presenting a graphical indication of the navigable path.

12. The method of claim 8, wherein the one or more live characteristics are associated with an availability of the EGM.

13. The method of claim 8, further comprising:
obtaining, from a third party system associated with a location on the digital map, one or more live characteristics for the location, wherein the location is presented in accordance with the one or more live characteristics for the location.

14. The method of claim 8, further comprising:
determining an additional target destination associated with the location on the digital map; and
in accordance with a determination that the additional target destination is outside the integrated physical environment:
presenting live characteristics for the additional target destination, and
presenting a directional indicator on the digital map toward the additional target destination.

15. A system comprising:
one or more processors; and
one or more computer readable media comprising computer readable code executable by the one or more processors to:
obtain a digital map of an integrated physical environment;
obtain location information for an electronic gaming machine (EGM) in the integrated physical environment;
obtain, from a casino management system, one or more live characteristics of the EGM; and
generate a mapping interface with an enhanced digital map based on the digital map and the one or more live characteristics of the EGM.

16. The system of claim 15, further comprising computer readable code to:
receive, from the mapping interface at a mobile device, a navigation request to the EGM; and
determine a navigable path from a current device location to a location of the EGM based on the location information for the EGM.

17. The system of claim 16, wherein the computer readable code to determine the navigable path comprises computer readable code to:
apply a cost-based algorithm within the digital map to identify a candidate path to minimize cost, wherein cost is determined based on at least one of a group consisting of: time to the EGM, distance to the EGM, promotional offers, traffic patterns, and accessibility.

18. The system of claim 16, further comprising computer readable code to:
present a graphical indication on the mapping interface of a local device; and
present a graphical indication of the navigable path.

19. The system of claim 15, wherein the one or more live characteristics are associated with an availability of the EGM.

20. The system of claim 15, further comprising computer readable code to:
obtain, from a third party system associated with a location on the digital map, one or more live characteristics for the location, wherein the location is presented in accordance with the one or more live characteristics for the location.
